(19) United States
(12) Patent Application Publication
(10) Pub. No.: US 2024/0356102 A1
(43) Pub. Date: Oct. 24, 2024

(54) Battery Module, and Battery Pack and Vehicle Including the Same

(71) Applicant: LG Energy Solution, Ltd., Seoul (KR)

(72) Inventors: Seung-Joon Kim, Daejeon (KR); Ho-June Chi, Daejeon (KR); Kyung-Woo Kim, Daejeon (KR); Eun-Gyu Shin, Daejeon (KR)

(73) Assignee: LG Energy Solution, Ltd., Seoul (KR)

(21) Appl. No.: 18/701,140

(22) PCT Filed: Dec. 21, 2022
(86) PCT No.: PCT/KR2022/021003

§ 371 Date: Apr. 12, 2024

(30) Foreign Application Priority Data
Dec. 24, 2021 (KR) 10-2021-0187838

(51) Int. Cl. H01M 10/6551; B60R 16/04; H01M 10/613; H01M 10/625; H01M 50/211; H01M 50/289

(52) U.S. Cl. CPC H01M 10/6551; B60R 16/04; H01M 10/613; H01M 10/625; H01M 50/211; H01M 50/289; H01M 2220/20

(57) ABSTRACT

A battery module according to an embodiment of the present disclosure includes a plurality of battery cells; a module housing accommodating the plurality of battery cells; and a heat dissipation pad accommodated in the module housing and located along at least one side of the plurality of battery cells. The heat dissipation pad includes at least one concave portion, and the concave portion has a form a such that an injected liquid resin is received within the concave portion.

### CROSS-REFERENCE TO RELATED APPLICATIONS

The present application is a national phase entry under 35 U.S.C. § 371 of International Application No. PCT/KR2022/021003 filed on Dec. 21, 2022, which claims priority to Korean Patent Application No. 10-2021-0187838 filed on Dec. 24, 2021, the disclosures of which are incorporated herein by reference.

### TECHNICAL FIELD

The present disclosure relates to a battery module, and a battery pack and a vehicle including the same.

### BACKGROUND ART

Secondary batteries, which have electrical characteristics such as high energy density, are commonly applied not only to product groups such as portable devices but also to electric vehicles (EVs), hybrid electric vehicles (HEVs), or the like driven by electric power sources. Since such secondary batteries have not only a primary advantage of dramatically reducing the use of fossil fuels, but also an advantage of generating no by-products from the use of energy, they are attracting attention as a new energy source to improve eco-friendliness and energy efficiency.

Secondary batteries widely used at present include lithium-ion batteries, lithium polymer batteries, nickel cadmium batteries, nickel hydrogen batteries, nickel zinc batteries, and the like. An operating voltage of a unit secondary battery cell is about 2.5 V to 4.5 V. Therefore, if a higher output voltage is required, a plurality of battery cells may be connected in series to produce a battery pack. In addition, depending on the charge/discharge capacity required for the battery pack, a plurality of battery cells may be connected in parallel to produce the battery pack. Thus, the number of battery cells included in the battery pack may be variously set according to the required output voltage or the demanded charge/discharge capacity.

Conventional battery packs include a plurality of battery cells, and there is commonly a liquid heat dissipation resin applied to cool irregular shapes of the plurality of battery cells. However, in such cases, there is a problem in that the liquid resin is difficult to handle and it takes a long time to harden.

In other conventional battery packs, a solid heat dissipation material may be used to cool simple shaped portions. However, the solid heat dissipation material has a problem in that cooling efficiency is lowered because it is difficult to fill the gaps of irregularly shaped cooling portions.

Therefore, in cooling a battery pack, there is a need to seek a heat dissipation pad that cool an irregular shape, has a short working time, and is easy to handle.

### DISCLOSURE

### Technical Problem

The present disclosure is designed to solve the problems of the related art, and therefore the present disclosure is directed to smoothly cooling a battery module including irregular shapes of a plurality of battery cells accommodated inside the battery module.

In another aspect, the present disclosure is directed to shortening the working time for applying a heat dissipation material in the manufacturing step of a battery module.

In still another aspect, the present disclosure is directed to facilitating handling when manufacturing a battery module.

However, technical problems to be solved by the present disclosure are not limited to the above-described problems, and other problems not mentioned herein may be clearly understood by those skilled in the art from the following description of the present disclosure.

### Technical Solution

A battery module according to an embodiment of the present disclosure for solving the above-described problems includes a plurality of battery cells; a module housing accommodating the plurality of battery cells; and a heat dissipation pad accommodated in the module housing, located on at least one side of the plurality of battery cells, provided with at least one concave portion, and having a form in which a liquid resin is injected into the concave portion.

Preferably, the heat dissipation pad may have an elasticity.

Preferably, the Shore 00 hardness of the heat dissipation pad may be in the range of 50 to 90 HS.

According to one aspect of the present disclosure, the heat dissipation pad may be deformed by pressure due to steps formed on one side of the plurality of battery cells to form a space between the plurality of battery cells and the heat dissipation pad.

Here, the battery module may include a liquid resin layer formed by allowing the liquid resin located in the concave portion to flow out into the space formed between the plurality of battery cells and the heat dissipation pad, wherein the liquid resin has a predetermined thickness.

According to another aspect of the present disclosure, the concave portion may have a perforated hole shape.

According to still another aspect of the present disclosure, the concave portion may have a groove shape extending in a straight line.

According to another aspect of the present disclosure, the heat dissipation pad may include a first pad in direct contact with the plurality of battery cells; and a second pad located on the opposite side of the plurality of battery cells based on the first pad and in contact with the first pad.

Here, the elasticity of the first pad may be greater than that of the second pad.

According to another aspect of the present disclosure, the concave portion may be provided only on the first pad.

According to still another aspect of the present disclosure, the liquid resin may be a curable liquid resin that hardens over time.

According to another aspect of the present disclosure, the battery module may further include a heat sink included inside the module housing and dissipating heat generated in the battery cell to the outside.

Preferably, the heat dissipation pad may be interposed between the plurality of battery cells and the heat sink.

Meanwhile, the present disclosure provides a battery pack including at least one battery cell according to the above-described embodiment as a battery pack.

In addition, the present disclosure provides a vehicle including at least one battery pack according to the above-described embodiment as a vehicle.

### Advantageous Effects

According to the present disclosure, in cooling a battery module, the battery module may be smoothly cooled despite irregular shapes of a plurality of battery cells accommodated inside the battery module.

In another aspect, according to the present disclosure, the working time for applying a heat dissipation material in the manufacturing step of a battery module may be shortened.

In still another aspect, according to the present disclosure, handling may be facilitated when manufacturing a battery module.

However, advantageous effects to be obtained by the present disclosure are not limited to the above-described effects, and other effects not mentioned herein may be clearly understood by those skilled in the art from the following description of the present disclosure.

### DESCRIPTION OF DRAWINGS

The accompanying drawings illustrate preferred embodiments of the present disclosure and, together with the accompanying disclosure, serve to provide further understanding of the technical features of the present disclosure. Thus, the present disclosure is not to be construed as being limited to the drawings.

FIG. 1 is a side cross-sectional view of a battery module according to an embodiment of the present disclosure.

FIG. 2 is an exploded perspective view of FIG. 1.

FIG. 3 is a perspective view of a battery cell included in the battery module of FIG. 1.

FIG. 4 is a perspective view of a heat dissipation pad according to an embodiment of the present disclosure.

FIG. 5 is a perspective view of a heat dissipation pad into which liquid resin has been injected according to an embodiment of the present disclosure.

FIG. 6 is a side diagrammatic view illustrating a state before a battery cell is applied to a heat dissipation pad according to an embodiment of the present disclosure.

FIG. 7 is a side diagrammatic view illustrating a state in which a battery cell is applied to a heat dissipation pad according to an embodiment of the present disclosure.

FIG. 8 is a side diagrammatic view illustrating a state in which liquid resin flows out after a battery cell is applied to a heat dissipation pad according to an embodiment of the present disclosure.

FIG. 9 is a perspective view of a heat dissipation pad according to another embodiment of the present disclosure.

FIG. 10 is a perspective view of a heat dissipation pad according to still another embodiment of the present disclosure.

FIG. 11 is a side cross-sectional, diagrammatic view illustrating part of a manufacturing process of the heat dissipation pad of FIG. 10.

FIG. 12 is a perspective view of a heat dissipation pad according to still another embodiment of the present disclosure.

FIG. 13 is a perspective diagrammatic view illustrating a battery pack including the battery module of FIG. 1.

FIG. 14 is a diagrammatic view illustrating a vehicle including the battery pack of FIG. 13.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but rather should be interpreted based on the meanings and concepts corresponding to technical aspects of the present disclosure, on the basis of the principle that the inventor is allowed to define terms appropriately for the best explanation.

Therefore, the description proposed herein is just a preferable example for the purpose of illustration only, not intended to limit the scope of the disclosure. Therefore, it should be understood that other equivalents and modifications could be made thereto without departing from the scope of the disclosure.

Also, in order to help understand the present disclosure, the accompanying drawings are not illustrated to scale, but instead the dimensions of some components may be exaggerated.

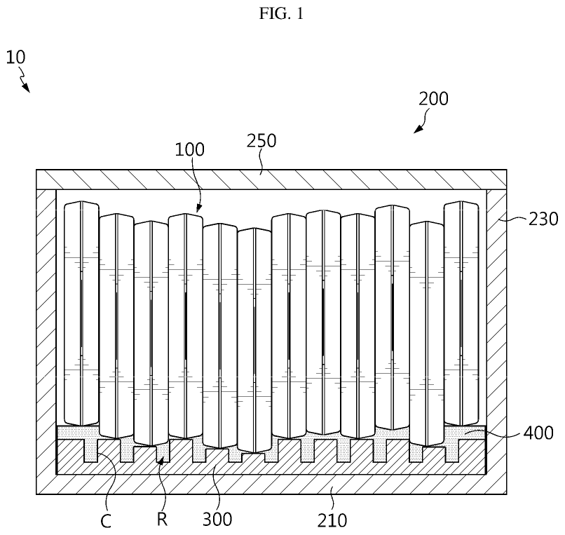

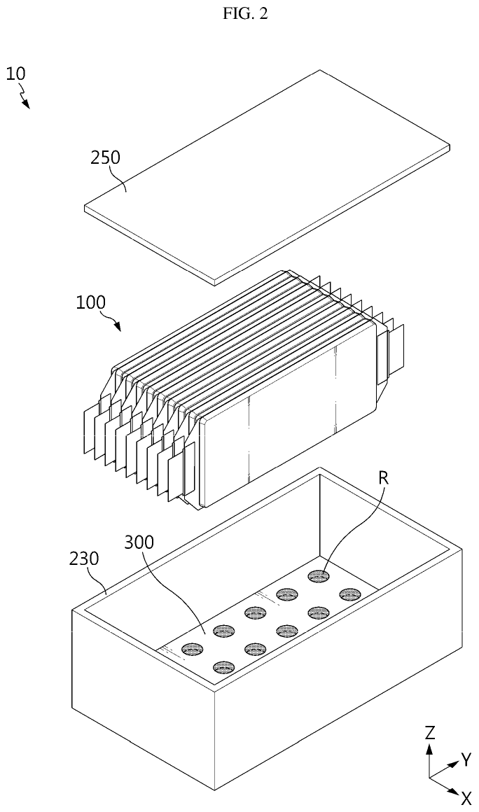

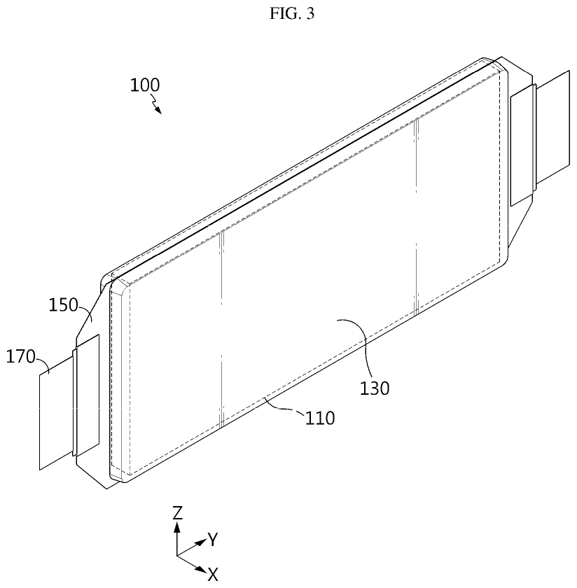

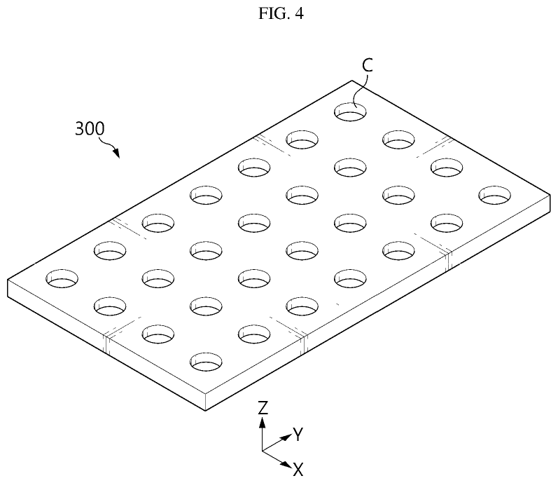

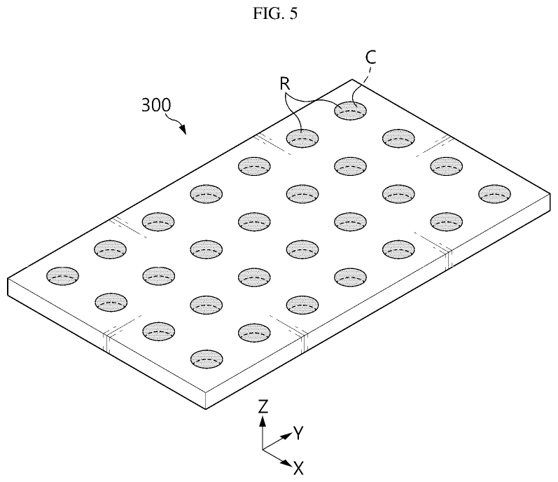

FIG. 1 is a side cross-sectional view of a battery module according to an embodiment of the present disclosure, and FIG. 2 is an exploded perspective view of FIG. 1. FIG. 3 is a perspective view of a battery cell included in the battery module of FIG. 1, FIG. 4 is a perspective view of a heat dissipation pad according to an embodiment of the present disclosure, and FIG. 5 is a perspective view of a heat dissipation pad into which liquid resin has been injected according to an embodiment of the present disclosure.

Referring to FIGS. 1 to 5, a battery module 10 according to an embodiment of the present disclosure may include a plurality of battery cells 100, a module housing 200, and a heat dissipation pad 300.

The battery cell 100, which is a secondary battery, may be provided as a pouch-type secondary battery, a prismatic secondary battery, or a cylindrical secondary battery. Hereinafter, in this embodiment, it will be the plurality of battery cells 100 will be described and illustrated as pouch-type secondary batteries. However, the present disclosure is not limited to the above embodiment only, and it is anticipated that a cylindrical secondary battery or a prismatic secondary battery may equally be applied to the present disclosure. Meanwhile, as shown in FIG. 1, the plurality of battery cells 100 in one embodiment of the present disclosure may be arranged to be stacked on each other along the width direction of the battery cells 100.

The module housing 200 may accommodate a plurality of battery cells 100. The module housing 200 may accommodate the heat dissipation pad 300.

The heat dissipation pad 300 may be accommodated in the module housing 200 and positioned on at least one side of the plurality of battery cells 100. Referring to FIGS. 4 and 5, at least one concave portion C may be provided in the heat dissipation pad 300. A liquid resin R may be injected into the concave portion C.

The heat dissipation pad 300 may be in a solid form. Therefore, since the overall shape of the heat dissipation pad 300 is maintained, heat conduction between heat sinks 500 (to be described later) may be minimized.

The heat dissipation pad 300 may transfer heat generated in the battery cell 100 to the outside. For example, the heat dissipation pad 300 may include a thermal interface material (TIM). The thermal interface material may be, for example, at least one of a heat dissipation grease, a thermally conductive adhesive, and a phase change material. The heat dissipation pad 300 may increase a contact area with the module housing 200 or a heat sink 500 to be described later. Accordingly, thermal conductivity may be improved.

Meanwhile, the liquid resin R may be a thermally conductive liquid resin R. That is, the liquid resin R may transfer heat generated in the battery cell 100 to the outside. The liquid resin R may be interposed between the battery cell 100 and the module housing 200 to fix the battery cell 100 in place.

According to such a structure, since the liquid resin R is injected only in a partial region of the heat dissipation pad 300, the curing time of the liquid resin R may be shortened. For example, if the amount of the liquid resin R is large, it takes a long time to harden, and thus work efficiency may be degraded. However, according to the present disclosure, since the liquid resin R is injected only into at least one concave portion C provided in the heat dissipation pad 300, the amount of the liquid resin R applied in the present disclosure may be maintained relatively small. As a result, the time required for curing is significantly reduced, and thus work efficiency may be improved. Furthermore, handling during the manufacturing operation of the battery module 10 may be facilitated.

Furthermore, according to the above structure, the entire surface of the battery cell 100 may be covered by the liquid resin R in a liquid form. Therefore, a contact area between the battery cell 100 and the liquid resin R or between the battery cell 100 and the heat dissipation pad 300 may be maximized. Accordingly, cooling efficiency may also be maximized. That is, according to the present disclosure, in cooling the battery module 10, it is possible to smoothly cool the battery module 10 despite the irregular shapes of the plurality of battery cells 100 accommodated inside the battery module 10.

Referring to FIG. 1 again, the heat dissipation pad 300 may have elasticity. For example, the hardness of the heat dissipation pad 300 may be in the range of about 40 to 95 HS in Shore 00 hardness. Shore hardness means the hardness defined by using the rebound height that an indenter bounces up after dropping it on the surface of the object. When the hardness of the heat dissipation pad 300 is less than about 40 HS in Shore 00 hardness, it is impossible to process or maintain the shape of the heat dissipation pad 300, which may cause difficulties in use. On the other hand, when the hardness of the heat dissipation pad 300 exceeds about 95 HS in Shore 00 hardness, the heat dissipation pad 300 does not adhere to the variation or shape of the battery cell 100 and maintains only its original shape, and thus application of the present disclosure may be difficult. Therefore, the hardness of the heat dissipation pad 300 may be in the range of about 40 to 95 HS in Shore 00 hardness. Preferably, the hardness of the heat dissipation pad 300 may be in the range of about 50 to 90 HS in Shore 00 hardness. More preferably, the hardness of the heat dissipation pad 300 may be in the range of about 10 to 60 HS in Shore A hardness.

According to the configuration in which the heat dissipation pad 300 has an elasticity force within the hardness range as described above, even if there are irregularities or steps in components of a portion in contact with the heat dissipation pad 300, the heat dissipation pad 300 may be deformed into a shape corresponding to the irregularities or steps. That is, in the present disclosure, the heat dissipation pad 300 may be deformed into a shape corresponding to the stepped shape of the battery cell 100 stack in contact with the heat dissipation pad 300. Accordingly, a contact area between the battery cell 100 and the heat dissipation pad 300 may be maximized. Cooling efficiency may also be maximized. That is, according to the present disclosure, in cooling the battery module 10, the battery module 10 may be smoothly cooled despite the irregular shapes of the plurality of battery cells 100 accommodated inside the battery module 10.

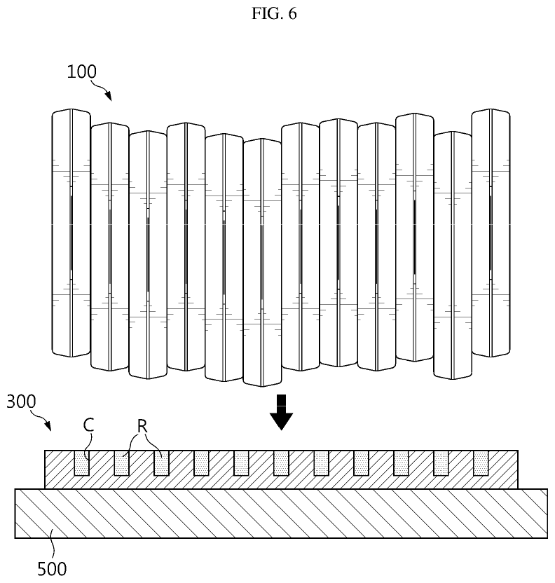

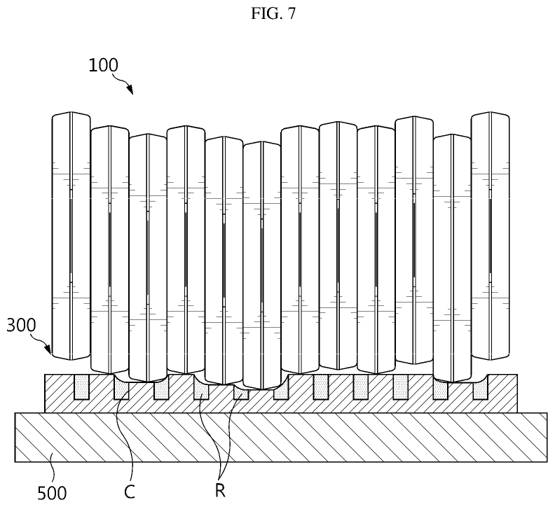

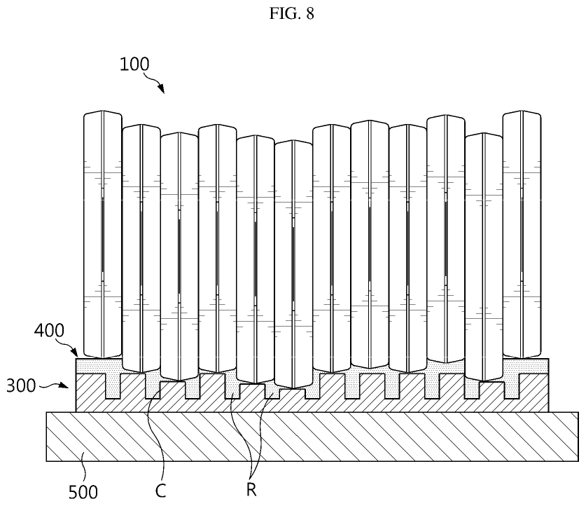

FIG. 6 is a side diagrammatic view illustrating a state before a battery cell is applied to a heat dissipation pad according to an embodiment of the present disclosure, and FIG. 7 is a side diagrammatic view illustrating a state in which a battery cell is applied to a heat dissipation pad according to an embodiment of the present disclosure. FIG. 8 is a side diagrammatic view illustrating a state in which liquid resin flows out after a battery cell is applied to a heat dissipation pad according to an embodiment of the present disclosure.

Referring to FIG. 6, a liquid resin R is injected into the concave portion C provided in the heat dissipation pad 300 according to an embodiment of the present disclosure. A plurality of battery cells 100 may be positioned in a direction toward the heat dissipation pad 300 from an upper portion of the heat dissipation pad 300.

Referring to FIG. 7, a plurality of battery cells 100 may be positioned on the heat dissipation pad 300. At this time, the heat dissipation pad 300 may be partially compressed by the load of the plurality of battery cells 100. Alternatively, a plurality of battery cells 100 may be press-fitted and fixed to the heat dissipation pad 300 by a manufacturing process of the battery module 10. That is, the heat dissipation pad 300 may be compressed by the load or additional pressure of the battery cell 100. Specifically, the heat dissipation pad 300 may be deformed by pressure due to steps formed on one side of the stack of the plurality of battery cells 100, so as to form a space between the plurality of battery cells 100 and the heat dissipation pad 300. The space may be temporarily formed and then filled with the liquid resin R later. FIG. 7 is a view illustrating a state in which the space is temporarily formed.

For example, a plurality of pouch-type battery cells 100 like that shown in FIG. 3 may be stacked on each other in the width direction (a direction parallel to the X-axis) of the battery cell 100. In such case, some errors between the battery cells 100 may occur in the height direction (a direction parallel to the Z-axis) of the battery cell 100 during the stacking process. For example, as shown in FIGS. 1 and 6, there may be an error in which the battery cells 100 are misaligned with each other in the height direction (a direction parallel to the Z-axis) of the battery cells 100. As an example, the error may be about 3 mm or less. When the battery cells 100 are stacked within this range, at least a portion of the battery cells 100 may be in contact with the heat dissipation pad 300 by deformation of the heat dissipation pad 300. Accordingly, the battery module 10 may be smoothly cooled despite some irregularities in the arrangement of the plurality of battery cells 100.

Referring to FIG. 8, the liquid resin R located in the concave portion C may flow out into the space formed between the plurality of battery cells 100 and the heat dissipation pad 300. As a result, a liquid resin layer 400 in which the liquid resin R has a predetermined thickness may be provided. As the liquid resin layer 400 is provided on top of the heat dissipation pad 300 as described above, one surface of the plurality of battery cells 100 having irregular shapes may be entirely covered by the liquid resin R. Therefore, a contact area between the battery cell 100 and the liquid resin R or between the battery cell 100 and the heat dissipation pad 300 may be maximized. Accordingly, cooling efficiency may also be maximized. That is, according to the present disclosure, in cooling the battery module 10, the battery module 10 may be efficiently cooled despite the irregular shapes of the plurality of battery cells 100 accommodated inside the battery module 10.

In another aspect of the present disclosure, since the liquid resin layer 400 is injected into the concave portion C of the heat dissipation pad 300, its volume may be relatively smaller than that of the heat dissipation pad 300. Therefore, since the amount of the liquid resin R is small, the curing time of the liquid resin layer 400 may be shortened. As a result, the time required for curing is significantly reduced, and thus work efficiency may be improved. Furthermore, handling during the manufacturing operation of the battery module 10 may be facilitated.

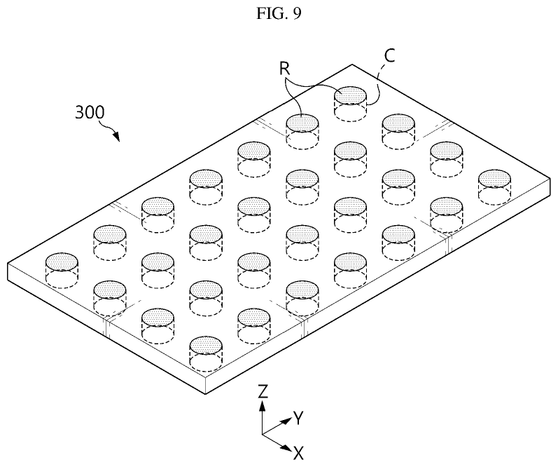

FIG. 5 is a perspective view of a heat dissipation pad into which liquid resin has been injected according to an embodiment of the present disclosure, and FIG. 9 is a perspective view of a heat dissipation pad according to another embodiment of the present disclosure.

Referring to FIGS. 5 and 9, the concave portion C may have a perforated hole shape. However, the shape of the concave portion C is not limited to a circular shape, and indeed any shape is possible as long as the shape is partially or fully recessed from the top of the heat dissipation pad 300.

As shown in FIG. 5, the concave portion C may be partially recessed without passing through the heat dissipation pad 300. In another embodiment, as shown in FIG. 9, the concave portion C may pass through the heat dissipation pad 300.

In an embodiment in which the concave portion C does not entirely penetrate the heat dissipation pad 300, as shown in FIG. 5, the liquid resin R does not flow down the heat dissipation pad 300 even after the liquid resin R is injected, and thus handling during operation may be facilitated. In addition, since the shape may be maintained to some extent even after injection and before curing, the time to proceed to the next process may be shortened.

In another embodiment, in which the shape of the concave portion C penetrates the heat dissipation pad 300, as shown in FIG. 9, a relatively large amount of the liquid resin R may be injected. In this case, when the heat dissipation pad 300 is compressed later and the liquid resin R flows out to form the liquid resin layer 400, the entire area exposed by the step of the battery cell 100 stack may be covered even if the step error of the battery cell 100 stack is relatively large.

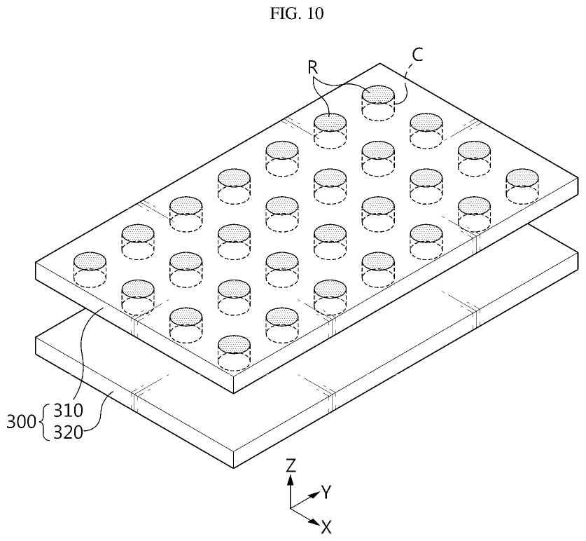

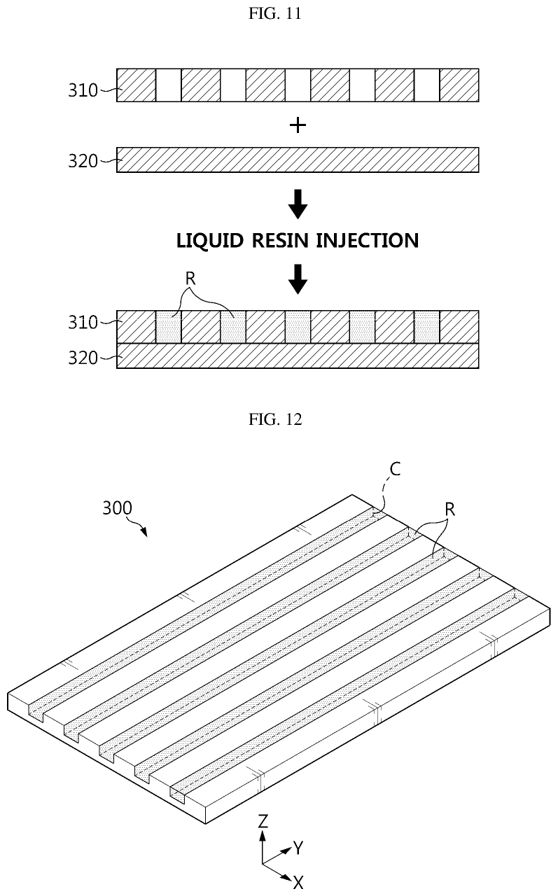

FIG. 10 is a perspective view of a heat dissipation pad according to still another embodiment of the present disclosure, and FIG. 11 is a side cross-sectional, diagrammatic view illustrating part of a manufacturing process of the heat dissipation pad of FIG. 10.

Referring to FIGS. 10 and 11, the heat dissipation pad 300 may include a first pad 310 in direct contact with the plurality of battery cells 100, and a second pad 320 in contact with the first pad 310 and located on the opposite side of the first pad 310 from the plurality of battery cells 100. That is, the heat dissipation pad 300 may be formed by coupling the first pad 310 and the second pad 320.

In an embodiment of the present disclosure, the concave portion C may be provided only on the first pad 310. For example, referring to FIG. 11, at least one concave portion C may be provided on the first pad 310, and the concave portion C may not be provided on the second pad 320. The concave portion C provided on the first pad 310 may penetrate the first pad 310 or may be partially recessed without penetrating the first pad 310. The first pad 310 and the second pad 320 may be vertically coupled. Thereafter, the liquid resin R may be injected into the concave portion C provided on the first pad 310. In a heat dissipation pad 300 of this type, the liquid resin R does not flow down under the heat dissipation pad 300 due to the second pad even after the liquid resin R is injected, and thus handling during operation may be facilitated. In addition, since the overall shape may be maintained by the second pad 320 even after injection and before curing, the time to proceed to the next process may be shortened.

In another aspect of the present disclosure, the elasticity of the first pad 310 may be greater than that of the second pad 320. That is, the hardness of the first pad 310 may be lower than that of the second pad 320. In such an embodiment, since the first pad 310 in direct contact with the battery cell 100 has a greater elasticity and a lower hardness, the first pad 310 may be easily deformed corresponding to the step of the battery cell 100 stack. At the same time, since the second pad 320 has a smaller elasticity and a higher hardness, the second pad 320 may firmly support the battery cell 100.

In another embodiment of the present disclosure, the first pad 310 and the second pad 320 may be made of the same material. Therefore, in such case, the first pad 310 and the second pad 320 may have the same elasticity and/or hardness.

FIG. 12 is a perspective view of a heat dissipation pad according to still another embodiment of the present disclosure.

Referring to FIG. 12, the concave portion C may have a groove shape extending in a straight line. When the concave portion C has a groove shape extending in a straight line in this way, the side surface of the pouch-type battery cell 100 extending in the longitudinal direction may be easily covered even if a step in the battery cell 100 stack occurs.

Referring to FIG. 3 again, the battery cell 100 may include an electrode assembly 110, an accommodating portion 130 accommodating the electrode assembly 110, a sealing portion 150 formed around the accommodating portion 130, and a pair of electrode leads 170 connected to the electrode assembly 110 and drawn out of the sealing portion 150. The pair of electrode leads 170 may be coupled to electrode tabs (not shown) provided in the electrode assembly 110, and the electrode leads 170 may be drawn out of the sealing portion 150 through the sealing portion 150. The pair of electrode leads 170 may have a shape extending along the longitudinal direction of the battery cell 100. The pair of electrode leads 170 may be drawn out in the same direction or in opposite directions.

In one aspect of the present disclosure, the liquid resin R may be a curable liquid resin R that hardens over time. For example, referring to FIG. 8, the liquid resin R flowing out of the concave portion C of the heat dissipation pad 300 may form a liquid resin layer 400 having a predetermined thickness and then harden. That is, the liquid resin R may harden while covering all exposed regions of the battery cells 100 caused by the step in the battery cell 100 stack. Accordingly, the plurality of battery cells 100 may be stably fixed by the cured liquid resin layer 400. The curable liquid resin R may be, for example, a one-component liquid resin R or a two-component liquid resin R. The one-component liquid resin R means a liquid resin R that hardens over time without a separate curing agent. The two-component liquid resin R means a liquid resin R that hardens by adding a separate curing agent. The curing method may be, for example, UV curing, moisture curing, or the like, but the curing method is not limited thereto.

Since the curable liquid resin R is in a liquid state before curing, it may harden in a state in which the contact area between the battery cell 100 and the liquid resin R is maximized. Since the liquid resin R has a heat dissipation function, cooling efficiency may be maximized according to such a structure. That is, according to the present disclosure, in cooling the battery module 10, the battery module 10 may be efficiently cooled despite the irregular shapes of the plurality of battery cells 100 accommodated inside the battery module 10.

The liquid resin R may include, for example, a urethane-based and/or silicon-based material. When including such a material, the liquid resin R may efficiently transfer heat generated from the battery cell 100 to the outside. At the same time, the liquid resin R may effectively fix the battery cell 100 in place in the module housing 200.

In another aspect of the present disclosure, the liquid resin R may be provided not only in the concave portion C of the heat dissipation pad 300, but also in another region inside the module housing 200. For example, the liquid resin R may fill an empty space in the module housing 200. In such an embodiment, the position of the battery cell 100 in the module housing 200 is fixed more definitely, so that the stability of the battery module 10 may be improved.

In another aspect of the present disclosure, the heat dissipation pad 300 into which the liquid resin R is injected may be provided not only on the bottom of the battery cell 100 but also on the top and/or side. For example, when the heat dissipation pad 300 is provided on the top of the battery cell 100, the plurality of battery cells 100 may first be fixed on top of the heat dissipation pad 300 to harden the liquid resin R, and then the fixed battery cell 100 and the heat dissipation pad 300 may be turned upside down so that the heat dissipation pad 300 may be finally positioned on the top of the battery cell 100. The reason for this is that, if the heat dissipation pad 300 were directly mounted on the top of the battery cell 100, the liquid resin R may flow down toward the battery cell 100 by gravity before the liquid resin R hardens.

Referring to FIGS. 6 to 8 again, the battery module 10 may further include a heat sink 500 positioned inside the module housing 200 for dissipating heat generated in the battery cell 100 to the outside.

For example, the module housing 200 may include a lower frame 210 disposed under the plurality of battery cells; a side frame 230 disposed on a side of the plurality of battery cells; and an upper frame 250 covering upper portions of the plurality of battery cells. Here, the heat sink 500 may be provided on the lower frame 210 of the module housing 200.

For example, referring to FIG. 8, the heat dissipation pad 300 may be interposed between the plurality of battery cells 100 and the heat sink 500. That is, the heat sink 500 may be disposed under the heat dissipation pad 300 disposed at the lower portion of the battery module 10. Therefore, heat transferred from the battery cell 100 to the heat dissipation pad 300 may then be transferred to the heat sink 500. Furthermore, the heat sink 500 may transfer the heat transferred from the heat dissipation pad 300 to separate cooling water or air. In an embodiment in which the battery module 10 additionally includes the heat sink 500 as described above, the heat dissipation effect of the battery module 10 may be further enhanced.

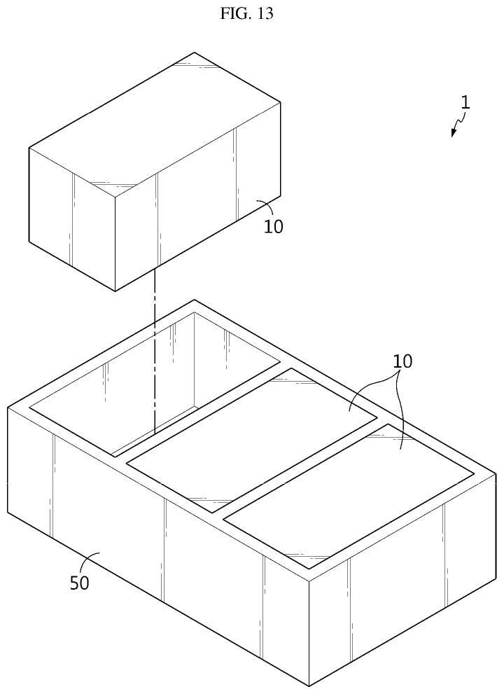

FIG. 13 is a perspective diagrammatic view illustrating a battery pack including the battery module of FIG. 1.

Referring to FIG. 13, a battery pack 1 according to the present disclosure may include at least one battery module 10 according to the present disclosure described above. In addition, the battery pack 1 according to the present disclosure may include a pack case 50 capable of accommodating one or more battery modules 10. Also, the battery pack 1 may further include, in addition to the battery module 10, other various components, for example, components of battery packs 1 known at the time of filing of the present disclosure, such as a BMS, a pack case, a relay, a current sensor, and the like.

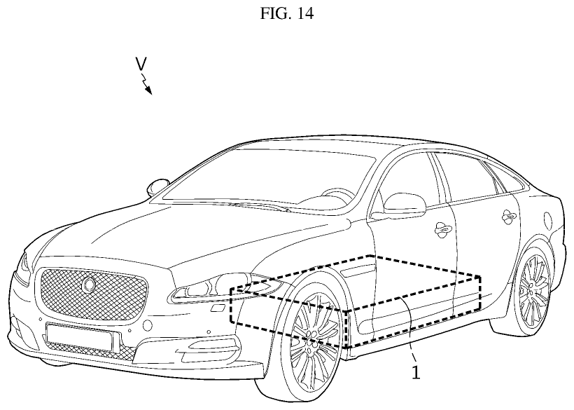

FIG. 14 is a diagrammatic view illustrating a vehicle including the battery pack of FIG. 13.

Referring to FIG. 14, a vehicle V according to the present disclosure may include at least one battery pack 1 according to the present disclosure.

According to various embodiments as described above, in cooling the battery module 10, the battery module 10 may be smoothly and efficiently cooled despite the irregular shapes of the plurality of battery cells 100 accommodated inside the battery module 10. In addition, since the amount of the liquid resin R applied according to the present disclosure may be maintained relatively small, the time required for curing may be significantly shortened, and thus work efficiency may be improved. Furthermore, handling during the manufacturing operation of the battery module 10 may be facilitated.

Therefore, according to the various embodiments as described above, there may be provided a battery module 10 having improved cooling and fixation performance, as well as a battery pack 1 and a vehicle V including the same.

Terms indicating directions as used herein, such as up and down, are used for convenience of description only, and it would be understood to those skilled in the art that the term may change depending on the position of the stated element or an observer.

While the present disclosure has been hereinabove described with regard to a limited number of embodiments and drawings, the present disclosure is not limited thereto, and it is to be understood to those skilled in the art that a variety of modifications and changes may be made thereto within the technical aspects of the present disclosure and the equivalent scope of the appended claims.

### REFERENCE SIGNS

V: vehicle
1: battery pack
10: battery module
50: pack case
100: battery cell
110: electrode assembly
130: accommodating portion
150: sealing portion
170: electrode lead
200: module housing
210: lower frame
230: side frame
250: upper frame
300: heat dissipation pad
C: concave portion
R: liquid resin
310: first pad
320: second pad
400: liquid resin layer
500: heat sink

1. A battery module comprising:
a plurality of battery cells;
a module housing accommodating the plurality of battery cells therein; and
a heat dissipation pad received within the module housing and positioned along at least one side of the plurality of battery cells, the heat dissipation pad including at least one concave portion defined therein, the at least one concave portion being configured to receive a resin therein in a liquid form.

2. The battery module according to claim 1,
wherein the heat dissipation pad has elasticity.

3. The battery module according to claim 1,
wherein the heat dissipation pad has a Shore 00 hardness in a range from 50 to 90 HS.

4. The battery module according to claim 1,
wherein the heat dissipation pad is deformed by pressure due to steps along the at least one side of the plurality of battery cells, so as to form a space between the plurality of battery cells and the heat dissipation pad.

5. The battery module according to claim 4,
further comprising a resin layer formed by allowing the resin in the liquid form located in the concave portion to flow out into the space formed between the plurality of battery cells and the heat dissipation pad, wherein the resin in the liquid form has a predetermined thickness.

6. The battery module according to claim 1,
wherein the concave portion perforates the heat dissipation pad by extending therethrough from a top surface to a bottom surface of the heat dissipation pad.

7. The battery module according to claim 1, wherein the concave portion has a groove shape extending along a straight line.

8. The battery module according to claim 2,
wherein the heat dissipation pad includes:
a first pad in direct contact with the plurality of battery cells; and
a second pad positioned in contact with the first pad on an opposite side of the first pad from the plurality of battery cells.

9. The battery module according to claim 8,
wherein an elasticity of the first pad is greater than an elasticity of the second pad.

10. The battery module according to claim 8,
wherein the e concave portion is included in the first pad without being included in the second pad.

11. The battery module according to claim 1,
wherein the resin is a curable liquid resin that hardens over time.

12. The battery module according to claim 1,
further including a heat sink positioned inside the module housing for dissipating heat generated in the battery cell to an area outside of the battery module.

13. The battery module according to claim 12,
wherein the heat dissipation pad is interposed between the plurality of battery cells and the heat sink.

14. A battery pack comprising at least one battery module according to claim 1.

15. A vehicle comprising at least one battery pack according to claim 14.
